(19) United States
(12) Patent Application Publication
(10) Pub. No.: US 2007/0094250 A1
(43) Pub. Date: Apr. 26, 2007

(54) Using matrix representations of search engine operations to make inferences about documents in a search engine corpus

(75) Inventor: Shyam Kapur, Sunnyvale, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Yahoo! Inc., Sunnyvale, CA (US)

(21) Appl. No.: 11/256,203

(22) Filed: Oct. 20, 2005

(51) Int. Cl. G06F 17/30

(52) U.S. Cl. 707/5

(57) ABSTRACT

In a computer system including a search engine that receives queries and returns search results comprising zero or more hits from a document index, a method of post-rocessing queries and results comprising collecting search sets, wherein a search set comprises a query and at least some set of the search results provided by the search engine in response to the query from a corpus, storing the plurality of search set in reference symbol storage, identifying an analysis set comprising at least two documents in the corpus to comparatively analyze, retreating from the retrievable storage search sets containing at least one document of the analysis set, thus obtaining a group of one or more search sets, generating an inference between the documents in the analysis set based on which is search sets occur in the group.

### FIELD OF THE INVENTION

The present invention relates in general to searching and navigating a corpus of documents or other content items, and in particular to analysis of search engine operations to make inferences about the search engine corpus.

### BACKGROUND OF THE INVENTION

The World Wide Web (web) provides a large collection of interlinked information sources (in various formats including documents, images, and media content) relating to virtually every subject imaginable. As the Web has grown, the ability of users to search this collection and identify content relevant to a particular subject has become increasingly important, and a number of search service providers now exist to meet this need. In general, a search service provider publishes a web page via which a user can submit a query indicating what the user is interested in. In response to the query, the search service provider generates and transmits to the user a list of links to Web pages or sites considered relevant to that query, typically in the form of a “search results” page. Searching techniques can also be used more generally for searching a corpus of documents and techniques useful for search results presentations might also find utility beyond searching.

Typically, a user inputs a query and a search process returns one or more links (in the case of searching the web), documents and/or references (in the case of a different search corpus) related to the query. The links returned may be closely related, or they may be completely unrelated, to what the user was actually looking for. The “relatedness” of results to the query may be in part a function of the actual query entered as well as the robustness of the search system (underlying collection system) used. Relatedness might be subjectively determined by a user or objectively determined by what a user might have been looking for.

In any case, many search engines have matured to where they provide relevant results in a reliable fashion. Often, the search engines rely on query history. For example, if a search engine receives millions of queries, it can determine common queries. If the search engine logs the queries and notes which of the search results users select (or, more generally, their click response to a search result presentation), the search engine can use its logic to weight documents differently. For example, if most searchers using a query “NY travel” react to a search result presentation by selecting a document entitled “Airfare to New York City”, the search engine might mark the document such that it appears first for subsequent search results for the query “NY travel”. By taking these steps over thousands of such examples, the search engine can refine its operations. However, these steps are often not in a form that one can learn relationships and make inferences. For example, it may be that the collective examples of the search engine are such that, in the aggregate, they define “NY” and “New York” synonymously but there is no identifying record that says “‘NY’ is the same as ‘New York’”.

As a result, it is often difficult to extract the learning that occurred in the operation of a search engine, which might be useful, for example, to find synonyms, infer relationships and/or test the performance of a search engine.

### BRIEF SUMMARY OF THE INVENTION

A search system is provided wherein queries presented to a search engine are logged, along with representations of the search results, wherein the search results for a query comprise one or more search hit deemed responsive to the query. These logs can be thought of as “query-results matrices”, or QR matrices. The QR matrices can be stored in an efficient form as needed, for example to accommodate millions of queries and tens, hundreds or maybe more than a thousand results for some queries. A QR matrix can be used to infer relationships from query to query, search hit to search hit, search hit to query, etc. From the basic form, a QR matrix can be transformed into a query vs. link matrix, query vs. anchor text matrix, concept unit vs. result, and other variations. One analysis that can be done is to infer relationships between documents that are search hits for a plurality of queries, while another analysis is to infer relationships between queries for which a document is a search hit for each of those queries.

Embodiments of the present invention provide systems and methods for processing search queries and/or results for various analysis processes. Analysis results could be fed back to the search engine or used to modify a search index, thereby forming a feedback loop to improve search results. Other analyses include evaluating search engines, reverse engineering search engines, inferring operations of search engines, etc., all from a study of a large number of queries and a large number of search results for those queries.

According to one aspect of the present invention, a computer-implemented method for analyzing such matrices (or data stored in other forms that could be represented by a matrix or other array of dimension two or more) is provided.

According to other aspects, embodiments in a computer system including a search engine that receives queries and returns search results comprising zero or more hits from a document index, a method of post-processing queries and results comprise collecting search sets, wherein a search set comprises a query and at least some set of the search results provided by the search engine in response to the query from a corpus, storing the plurality of search set in reference symbol storage, identifying an analysis set comprising at least two documents in the corpus to comparatively analyze, retreating from the retrievable storage search sets containing at least one document of the analysis set, thus obtaining a group of one or more search sets, generating an inference between the documents in the analysis set based on which is search sets occur in the group.

The following detailed description together with the accompanying drawings will provide a better understanding of the nature and advantages of the present invention.

### BRIEF DESCRIPTION OF THE DRAWINGS

FIG. 1 is a block diagram of a communication network according to an embodiment 20 of the present invention within which a search engine and analysis system might operate.

FIG. 2 is a block diagram of a search server and other elements, such as a post-processor with an inference engine.

FIG. 3 illustrates query-result (QR) matrices; FIG. 3A shows a binary QR matrix and FIG. 3B shows a QR matrix wherein a cell's value corresponds to a rank order of the cell's column's result for a query corresponding to the cell's row.

### DETAILED DESCRIPTION OF THE INVENTION

Embodiments of the present invention provide systems and methods allowing users to view search results from a corpus of documents or other content items (e.g., the World Wide Web). As used herein, a “query” is a data set submitted to a search engine by a user (a human or computer querier) in some form. A common query format is a query string plus metadata and user demographic data. A simple query might be one that is just a query string that is processed by the search engine without any other context data. In response to a query, the search engine consults data structures to identify documents matching the query from a search corpus. The search corpus can be centralized or distributed and documents can come in many forms, such as files, images, text sequences, web pages, etc. wherein each document is generally separately manipulable. An example of a search corpus is the World Wide Web, a collection of hyperlinked documents available over the Internet. The consulted data structures might be page indices that have received large numbers of references to web pages from, for example, a crawler. The search results comprise one or more documents deemed responsive to the query called “hits” or “search hits”. A search hit is deemed responsive to the query by the search engine, but it might not in fact be a document that the user is interested in or feels is responsive to the query. One measure of the quality and performance of a search engine is how often the search hits it deems responsive to the query are deemed responsive by the querier.

For purposes of illustration, the present description and drawings may make use of specific queries, search result pages, URLs, and/or Web pages. Such use is not meant to imply any opinion, endorsement, or disparagement of any actual Web page or site. Further, it is to be understood that the invention is not limited to particular examples illustrated herein.

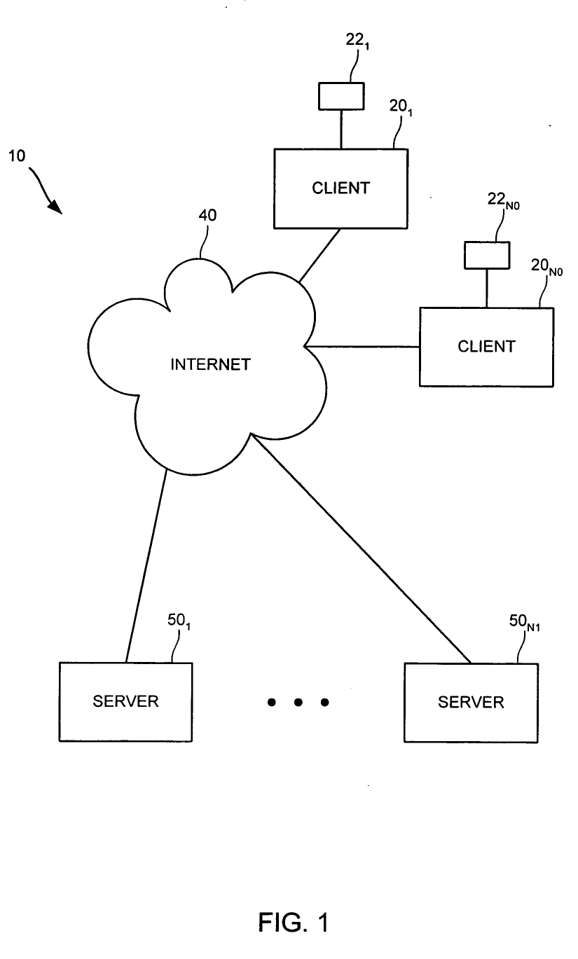

FIG. 1 illustrates a general overview of an information retrieval and communication network 10 including a number of client systems 20₁ to 20_{NO} according to an embodiment of the present invention. In computer network 10, each client system 20 might be coupled through the Internet 40, or other communication network, e.g., over any local area network (LAN) or wide area network (WAN) connection, to any number of server systems 50₁ to 50_{N1}.

As will be described herein, client system 20 is configured according to the present invention to communicate with any of server systems 50₁ to 50_{N1}, e.g., to access, receive, retrieve and display media content and other information such as web pages. As used herein, where a plurality of instances of an object are shown and the actual number of instances is not important, the object might be called out with a reference number and the instances distinguished by subscripts running from 1 to the number of instances. In many cases, the number of instances is not important, so the last instance is represented with an arbitrary subscript without a defined value, such as “N1”. Where different terminal subscripts are used, it should not be inferred one way or the other whether there are different numbers of instances of the differently labelled objects, unless otherwise specified. In other words, “NO” might or might not be equal to “N1”, but if their relationship is important, that is so indicated.

Several elements in the system shown in FIG. 1 include conventional, well known elements that need not be explained in detail here. For example, client system 20 could include a desktop personal computer, workstation, laptop, personal digital assistant (PDA), cell phone, or any WAP enabled device or any other computing device capable of interfacing directly or indirectly to the Internet. Client system 20 typically runs a browsing program, such as Microsoft's Internet Explore™ browser, Netscape Navigator™ browser, Mozilla™ browser, Opera™ browser, or a WAP enabled browser in the case of a cell phone, PDA or other wireless device, or the like, allowing a user of client system 20 to access, process and view information and pages available to it from server systems 50₁ to 50_{N} over Internet 40. Client system 20 also typically includes one or more user interface devices 22, such as a keyboard, a mouse, touch screen, pen or the like, for interacting with a graphical user interface (GUI) provided by the browser on a display (e.g., monitor screen, LCD display, etc.), in conjunction with pages, forms and other information provided by server systems 50₁ to 50_{N} or other servers. The present invention is suitable for use with the Internet, which refers to a specific global internet work of networks. However, it should be understood that other networks can be used instead of or in addition to the Internet, such as an intranet, an extranet, a virtual private network (VPN), a non TCP/IP based network, any LAN or WAN or the like.

According to one embodiment, client system 20 and all of its components are operator configurable using an application including computer code run using a central processing unit such as an Intel Pentium™ processor, AMD Athlon™ processor, or the like or multiple processors. Computer code for operating and configuring client system 20 to communicate, process and display data and media content as described herein is preferably downloaded and stored on a hard disk, but the entire program code, or portions thereof, may also be stored in any other volatile or non volatile memory medium or device as is well known, such as a ROM or RAM, or provided on any media capable of storing program code, such as a compact disk (CD) medium, a digital versatile disk (DVD) medium, a floppy disk, and the like. Additionally, the entire program code, or portions thereof, may be transmitted and downloaded from a software source, e.g., from one of server systems 501 to 50N to client system 20 over the Internet, or transmitted over any other network connection (e.g., extranet, VPN, LAN, or other conventional networks) using any communication medium and protocols (e.g., TCP/IP, HTTP, HTTPS, Ethernet, or other conventional media and protocols).

It should be appreciated that computer code for implementing aspects of the present invention can be C, C++, HTML, XML, Java, JavaScript, etc. code, or any other suitable scripting language (e.g., VBScript), or any other suitable programming language that can be executed on client system 20 or compiled to execute on client system 20. In some embodiments, no code is downloaded to client system 20, and needed code is executed by a server, or code already present at client system 20 is executed.

However, it is done, a display of search results is available for presentation to the searcher that presented the query, which is typically a human user of a computer system, but that need not be the case.

Software needed to show search results might include a conventional web browser or a special-purpose web browser coupled to a search system. In one implementation, the search system includes a conventional search engine that receives search queries from tens, hundreds, thousands or even millions of client systems and provides sets of search hits responsive to those search queries to a system that handles post-search results manipulation for the user as part of analyzing and/or processing the search results or post-processes queries and results for other analysis tasks.

The presentation system can be a dedicated search environment implemented as a desktop application (e.g., a customized web browser), by a combination of server-based and client-based tools or by other methods.

Search System

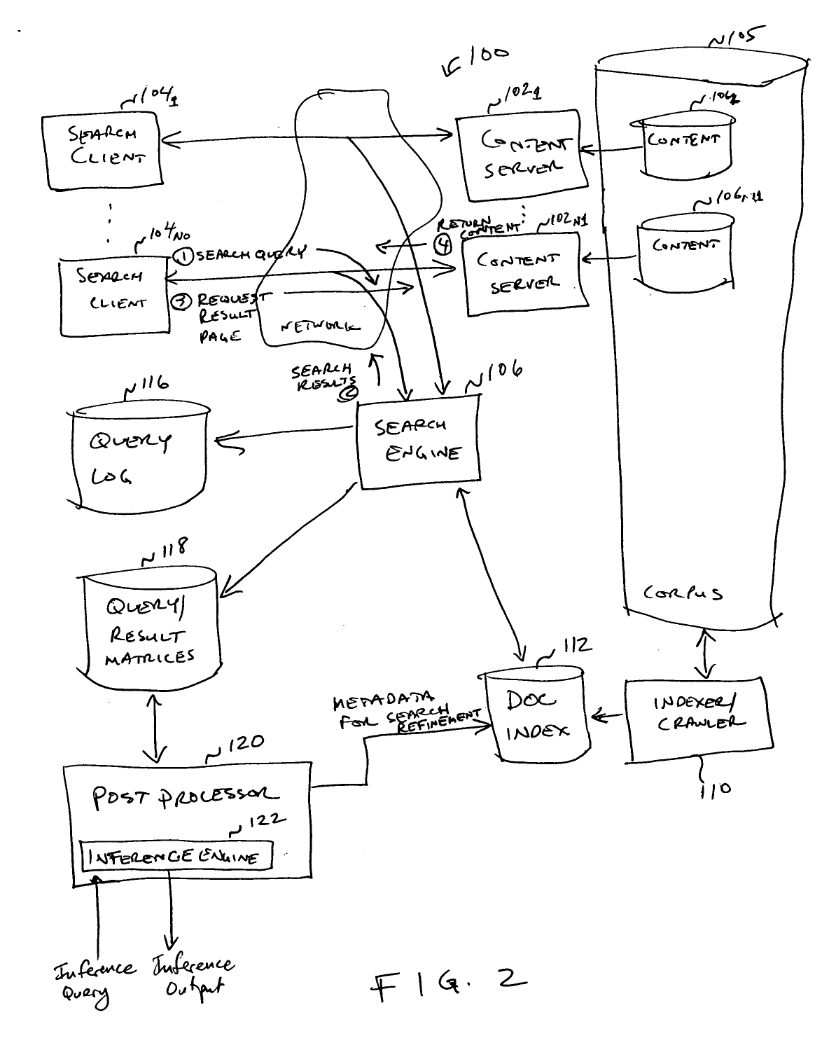

FIG. 2 illustrates a search system 100 in greater detail. As shown there, search clients 104 connected with content servers 102 that serve content 106 from a corpus 105. For example, search clients 104 might be computers with web browsers, content servers 102 might be web servers and content 106 might be repositories of web pages. Search clients 104 can also connect to a search engine 106 to identify content of interest. In an example operation, a search client 104 issues a search query to search engine 106, which returns search results to the search client. Where the search results references content, the user of search client 104 can then access that content indexed by the search engine, by making a request to a relevant content server that will return the content in response to the request.

Prior to searches being done, an indexer/crawler 110 would create a document index 112 for the corpus 105 to allow for searching over the content for relevant documents. Search engine 106 is coupled to this document index 112. Search engine 106 is also coupled to storage for a query log 1 16 and storage for query-result matrices 118 (“matrix storage”). A post-processor 120 is coupled to read (and write, as needed) matrix storage 118 for performing analysis, including the use of an inference engine 122. Post-processor 120 might be coupled to document index 112 to update the indices with information gleaned from analysis processes.

In operation, possibly millions of search clients send queries to search engine 106, which consults document index 112 and returns search results to the search clients. Search engine 106 also logs the queries in query log 116 and updates matrix storage 118 with queries and the results. The search results could be such that each of the hits refers back to search engine 106 or other server that tracks which search engine hits are selected, or the search results could point directly to the appropriate content server. Either way, the searcher typically response to search results by following the links or references to one or more of the search hits.

Post-processor 120 reads from matrix storage 118 in order to make inferences about search engine 106, inferences about the collected and logged queries and/or inferences about the results that correspond to the queries. The inference engine might operate according to an inference query provided to the inference engine and then output the corresponding inference output. For example, an inference query might be “What other search results are deemed (by the search engine) to be similar to document D?” or “Does the search engine deem document A and document B to be related?”. Notice that the latter question is different from an inquiry as to whether document A and document B are related, which might be answered by a process of analyzing content of the two documents independent of a search process.

Client System

According to one embodiment, a client application executing on a client system includes instructions for controlling the client system and its components to communicate with a server system to process and display data content received therefrom. The client application can be transmitted and downloaded to the client system from a software source such as a remote server system, although the client application can be provided on any software storage medium such as a floppy disk, CD, DVD, etc.

Additionally, the client application module includes various software modules for processing data and media content, a user interface for rendering data and media content in text and data frames and active windows, e.g., browser windows and dialog boxes, and an application interface for interfacing and communicating with various applications executing on the client. Examples of various applications executing on the client system invention include various e-mail applications, instant messaging (IM) applications, browser applications, document management applications and others. Further, the interface may include a browser, such as a default browser configured on the client system or a different browser. In some embodiments, the client application provides features of a universal search interface.

Search Server System

Search engine 106 in one embodiment references various page indexes stored in document index 112 that are populated with, e.g., pages, links to pages, data representing the content of indexed pages, etc. Page indexes may be generated by various collection technologies including automatic web crawlers, spiders, etc., as well as manual or semi-automatic classification algorithms and interfaces for classifying and ranking web pages within a hierarchical structure.

Search engine 106 may be configured with search related algorithms for processing and ranking web pages relative to a given query (e.g., based on a combination of logical relevance, as measured by patterns of occurrence of the search terms in the query; context identifiers; page sponsorship; etc.).

It will be appreciated that the search system described herein is illustrative and that variations and modifications are possible. The content servers and search engine may be part of a single organization, e.g., a distributed server system such as that provided to users by Yahoo! Inc., or they may be part of disparate organizations. Each associated database system may include multiple servers and associated database systems, and although shown as a single block, may be geographically distributed. For example, all servers of a search engine system may be located in close proximity to one another (e.g., in a server farm located in a single building or campus), or they may be distributed at locations remote from one another (e.g., one or more servers located in city A and one or more servers located in city B). Thus, as used herein, a “server” typically includes one or more logically and/or physically connected servers distributed locally or across one or more geographic locations; the terms “server” and “server system” are used interchangeably.

The search system may be configured with one or more page indexes and algorithms for accessing the page index or indices and providing search results to users in response to search queries received from client systems. The search server system might generate the page indexes itself, receive page indexes from another source (e.g., a separate server system), or receive page indexes from another source and perform further processing thereof (e.g., addition or updating of the context identifiers).

Matrix Storage and Post-Query Processing

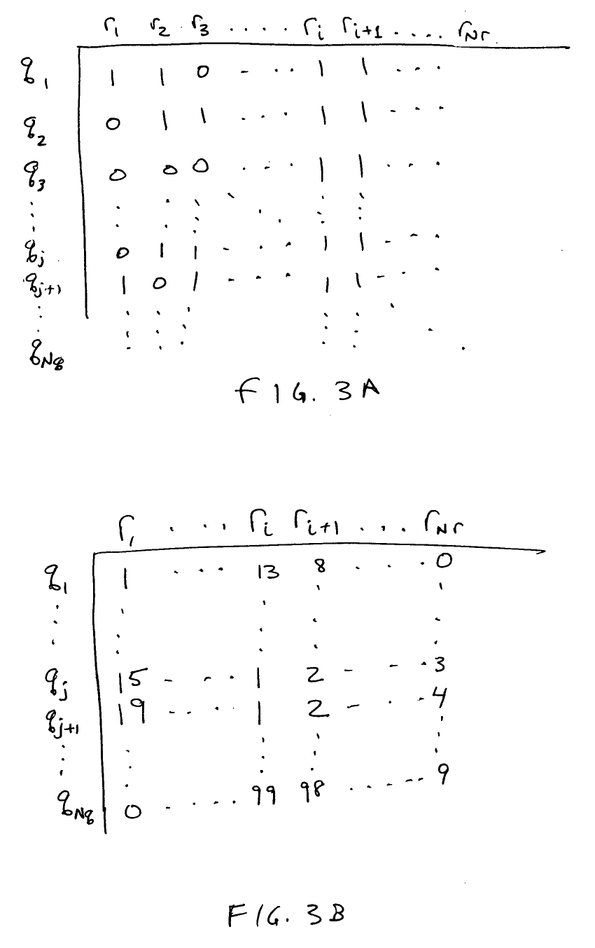

Several organizations of matrix storage 118 are possible and more than one organization for queries and results might be used simultaneously. In a first example, matrix storage 118 includes a two-dimensional array of queries and results, such as that shown in FIG. 3A, and representable as a matrix.

Each row of the matrix shown in FIG. 3A corresponds to a query. Not all queries need be represented and in some embodiments the order of queries does not matter. In one embodiment however, the queries are ordered by frequency of occurrence (i.e., by how often users submit those queries) and after some number, Nq, of queries, the less frequent queries are ignored and not present in the matrix.

Each column of the matrix shown in FIG. 3A corresponds to a search hit, such as a web page, document, unit of data, etc. returned in response to a query. The results need not be in any order, but might be ordered by some metric that allows for less used documents in the corpus to be discarded to maintain a smaller matrix.

Each cell in the matrix has a value, such as “0” or “1”. The cell value for the j-th row and i-th column is a “1” if result rᵢ is a result that is returned in response to a search with query qⱼ. As the number of queries and the number of results can be quite large, the matrix might be stored in a compressed form. Also, the number of results per query might be truncated, such that each row of the matrix only has ten, a hundred, or some other number of “1”s, representing the highest ranked results for the query. For example, results beyond the fifty most highly rated results for a query might be ignored.

FIG. 3B shows an alternative matrix, wherein cells contain values that represent a hit's ranking. For example, as shown in the figure, where query qⱼ returns search results with the most highly rated result being rᵢ followed by rⱼ₊₁, the corresponding cells would hold a “1” and a “2”.

Where the corpus is documents identified by URLs, each result column could correspond to a unique URL. In other variations, the columns correspond to anchor text found in the search results, links (in links or out links) for the search hits (in links might be found by scanning the document index to find which documents point to the search hits) or other variations apparent after review of this disclosure.

Likewise, instead of the rows corresponding to queries, the rows can correspond to groups of queries, concepts distilled from queries, or the like. In each of the cases however, the matrix maps in some way inputs to a search engine and outputs from the search engine, at least in part. Also, while rows are used in these examples to correspond to the search engine inputs and columns to the search engine outputs, these are arbitrary choices.

For many of the examples, the rows (search engine inputs) initially correspond to unique queries and the columns (search engine outputs) initially correspond to unique hits and thus the cells of a row correspond to the search results for a query, it should be apparent how to vary these examples to correspond to the varied arrangements of inputs and outputs. Further, it should be understood that the full matrix can be compressed and still be as useful. For example, where the matrix represents rank order of the top 100 search hits for each of a million queries and the number of documents that could be in the search results is over a billion, a million by billion array (a quadrillion cells) of URLs is not needed. Instead, the URL's for the top 100 search hits for each query could be stored as an ordered list (possibly itself compressed). Thus, even for a million queries, if each URL can be represented by an average of 100 bytes, the matrix can be stored with 10,000 bytes per query on average, thus fitting nicely into a 10 gigabyte memory. It should be apparent that the information content of either structure is the same.

As used herein, a “row vector” refers to the matrix entries corresponding to a row, e.g., the search results corresponding to a query, and a “column vector” refers to the matrix entries corresponding to a column, e.g., an indication of the queries for which the column's result applies. Since many queries and results do not relate, these can be expected to be sparse vectors.

Vectors can be correlated. For example, correlating column vectors i and i+1 shows more correlation (for the cells actually illustrated, at least) than column vectors 3 and i. From that, the post-processor can infer that the search engine deemed documents rᵢ and rᵢ₊ₗ to be more similar than documents r₃ and rᵢ. Note that it is entirely possible that, given two documents, a person might determine that the documents are so unrelated that there is no reasonable query that would return both documents, yet there still be a nonzero correlation, because the correlations found in analyzing the matrix relate to what the search engine deems, not what a reader might deem. That difference leads to interesting conclusions, some of which are set forth herein.

Applications

One application of such a matrix is in organizing the space of documents in the corpus such that two documents that have similar columns are deemed similar. Improved search ranking algorithms can be used to fuel these document comparisons. In addition to grouping documents by grouping their columns, analysis of the matrix can be used to cluster queries. In an iterative process, the queries might be clustered according to some other approach, the matrix reorganized accordingly and then clustering performed on documents in the results set (columns) to reduce the number of columns, then the queries reclustered as represented in the matrix. Logically, this could be represented as identifying rectangular sections of the matrix enclosing the cells corresponding to a plurality of queries and a plurality of results such that each of the results are relevant to each of the queries.

Such a distillation of the matrix might be supplemented by eigenvector analysis, page ranking processes, or the like. With such rectangles identified (by the post-processor or elsewhere), the search engine might use the results to improve ranking processes. For example, if a search engine is processing a current query to identify a suitable set of search result hits, it could obtain an analysis of the matrix and include (or up-rank) results that were not presented for a previous query identical to the current query but were presented for a query deemed similar to the current query, thus using relationships extracted from the matrix to find (or up-rank) related results.

A related technique is “co-clustering”, wherein two queries, q1 and q2, are deemed related, even if they are lexically unrelated, because their result sets overlap considerably.

Once some of the queries have been labeled, categorized or otherwise characterized, other queries can be labeled, categorized or otherwise characterized is well. Similarly, such processes done for some of the documents represented by some columns can be spread to unknown documents by considering their deemed similarity in the matrix. In some cases, a categorization of rows or columns could be used as a cross check of a categorization done by an entirely different method.

As an example, if the search engine had a knowledge that a first query and a second query were synonymous in that knowledge was obtained from some other method, and an analysis of a QR matrix showed that the matrix rows for those to queries did not correlate, then the search engine might infer that the synonym provided by the other method might be incorrect. Some of the other methods used might include the use of concept networks, super units or dictionary lookup synonym identifiers, or consideration of the hosts and/or filenames (e.g., pages on the same host might be similar and pages on different hosts with the same filename might be similar) or the search engine ranking is not very good and needs to be improved upon.

Query-Query Matrices

Another interesting variation is the query-query matrix, which is a binary-cell matrix with queries as rows and queries as columns, indicating for each pair of queries whether they would return any document in common. In a variation, each cell has a value (with more than two values possible) representing the number of documents in common between the row query and the column query.

Search Engine Tuning

Analysis from the QR matrix might be used to improve search engine performance, assuming that the search engine operating entity and the post-processing entity is the same or cooperating entities. One approach to search engine improvement is to evaluate the data and come up with interesting query terms (or all of the query terms) and add them to the phrases findable in the document index. In effect, this could attach metadata to a document, in effect “this document was deemed relevant by a good search engine and the search engine returned this document in response to the query Qₓ”.

Reverse Engineering

Search Engine Optimizers (SEOs) are organizations that advise clients on having their pages more highly ranked in search engines. Some advice is legitimate (“become a respected source”, “keep each page focussed on a topic”) and some is not so legitimate (“add piles of keywords in hidden text”, “insert your competitor's trademarks”), where legitimacy might relate to how much the searching public would up-rank a page if the advice was followed. In either case, by performing post-search analysis using arrays of search inputs and outputs, SEOs can “reverse engineer” a search engine. Notably, even if the SEO does not have access to all of the millions of queries that pass through the search engine, it can generate a representative set of queries, apply those queries to the search engine and build a matrix of queries and results.

Other Applications

Using matrices of the type described above, given a new document, a post-processor or search engine can figure out which document(s) in the corpus the new document is most like. Likewise, using matrices of the type described above, given a new query, a post-processor or search engine can figure out which known query or queries are most like the new query.

Generalizing, the rows of such a matrix could correspond to queries or other elements derived from queries or, directly or indirectly, related to queries. For example, the rows could correspond to the user or particular demographics of the user who made them. They could correspond to user sessions in which they were made. Furthermore, the columns could correspond to search results or other elements derived from search results or, directly or indirectly, related to them. For example, they could correspond to web sites, the URL, the popularity of the web page/site, the depth of the URL, complexity of the web page or web site, etc.

Other applications might include comparing search engine relevance, comprehensiveness, freshness, etc. by considering their relative matrices.

Matrixes arising in different contexts could be compared. For example, by comparing a matrix obtained from web search versus one obtained from a product search, one could detect ambiguities in concept meaning in different contexts. For example, if query clusters look very different on two contexts, this might mean that the queries quite likely have different senses in those different contexts.

The above techniques can also be used for summarizing documents or web sites. By looking at queries corresponding to the documents or web sites, a post-processor or search engine can discover what is important within documents or web sites. Standard techniques could be used to use these queries to build more readable summaries for documents or web sites.

Further Embodiments

While the invention has been described with respect to specific embodiments, one skilled in the art will recognize that numerous modifications are possible. For instance, the number and specificity of dimensions and subsets of queries and results may vary, and not all 5 queries and results need be used for analysis. The automated systems and methods described herein may be augmented or supplemented with human review of all or part of the resulting data.

In an alternative storage organization, instead of compressing a QR matrix into ordered lists per query row, it might be compressed into ordered lists of query identifiers per result (i.e., storage of one record per document representing a list of queries that returned the document as a search hit). In a measure of “web spam” detection, documents can be weighted by how long such ordered lists of query identifiers are, with the observation that pages that return for a large number of different kinds of queries are probably web spam or are uninteresting in search results for similar reasons (i.e., even a legitimate page of rambling prose would be down-weighted if it was hit by too many queries).

The embodiments described herein may make reference to web sites, links, and other terminology specific to instances where the World Wide Web (or a subset thereof) serves as the search corpus. It should be understood that the systems and processes described herein can be adapted for use with a different search corpus (such as an electronic database or document repository) and that results may include content as well as links or references to locations where content may be found.

Thus, although the invention has been described with respect to specific embodiments, it will be appreciated that the invention is intended to cover all modifications and equivalents within the scope of the following claims.

What is claimed is:

1. In a computer system including a search engine that receives queries and returns search results comprising zero or more hits from a document index, a method of post-processing queries and results comprising:
collecting search sets, wherein a search set comprises a query and at least some of the search results provided by the search engine in response to the query from a corpus;
storing the plurality of search sets in referenceable storage;
identifying an analysis set comprising at least two documents in the corpus to comparatively analyze;
retrieving, from the referenceable storage, search sets containing at least one document of the analysis set, thus obtaining a group of one or more search sets; and
generating an inference between the documents in the analysis set based on which search sets occur in the group, thereby comparatively analyzing the documents identified.

2. The method of claim 1, wherein the inference relates to a degree of similarity of documents in the analysis set based on correlations of result vectors, wherein a result vector for a document is a representative of which search sets contained that document as one of its search results.

3. The method of claim 1, wherein the inference relates to categorization of documents based on a known categorization of at least one document represented in the analysis set and an unknown categorization of at least one other document represented in the analysis set.

4. The method of claim 1, wherein the inference further relates to categorization of queries in the analysis set.

5. The method of claim 1, wherein the inference relates to how a search engine evaluated the documents in the analysis set.
